(19) United States
(12) Patent Application Publication
(10) Pub. No.: US 2014/0367330 A1
(43) Pub. Date: Dec. 18, 2014

(54) WASTEWATER TREATMENT PROCESS THAT UTILIZES GRANULAR SLUDGE TO REDUCE COD CONCENTRATION IN WASTEWATER

(71) Applicant: VEOLIA WATER SOLUTIONS & TECHNOLOGIES SUPPORT, Saint-Maurice (FR)

(72) Inventors: Wenjun Liu, Wayne, PA (US); Graig Rosenberger, Mullica Hill, NJ (US); Abraham Izaak Versprille, Overveen (NL)

(73) Assignee: VEOLIA WATER SOLUTIONS & TECHNOLOGIES SUPPORT, Saint-Maurice (FR)

(21) Appl. No.: 14/305,493

(22) Filed: Jun. 16, 2014

Related U.S. Application Data
(60) Provisional application No. 61/835,843, filed on Jun. 17, 2013.
(60) Provisional application No. 61/907,640, filed on Nov. 22, 2013.

(51) Int. Cl. C02F 3/28; C02F 3/34; C02F 3/30

(52) U.S. Cl. CPC C02F 3/2806; C02F 3/307; C02F 3/341
USPC 210/605; 210/601; 210/631; 210/615; 95/263

(57) ABSTRACT

A wastewater treatment process that employs anaerobic granular sludge or biomass to remove chemical oxygen demand (COD) from the wastewater. Certain constituents, such as COD, nitrogen, calcium, other dissolved solids, suspended solids, can impair the effectiveness of the granular biomass. Thus, the process employs treatment units to remove these inhibiting constituents to produce a treated effluent or stream. At least a portion of the treated effluent is recycled and mixed with the influent wastewater to reduce the concentration of these inhibiting constituents.

This application claims priority under 35 U.S.C. §119(e) from the following U.S. provisional applications: Application Ser. No. 61/835,843 filed on Jun. 17, 2013 and Application Ser. No. 61/907,640 filed Nov. 22, 2013. These applications are incorporated in their entirety by reference herein.

### FIELD OF THE INVENTION

The present invention relates to wastewater treatment processes and more particularly to a granular sludge process where granular biomass is employed to reduce the chemical oxygen demand (COD) of the wastewater.

### BACKGROUND OF THE INVENTION

One of the problems with employing granular sludge to treat wastewater is that granular sludge is difficult to employ when the wastewater includes a relatively high COD concentration, such as, for example, a COD concentration in excess of 20,000 mg/L. This is because of what is referred to herein as inhibiting constituents in the wastewater. There are various inhibiting constituents typically found in wastewater streams that impair the effectiveness of granular sludge processes. For example, concentrations of calcium and/or magnesium or other total dissolved solids or salts can adversely impact a granular sludge process designed to remove COD from a wastewater stream. In particular, and in the way of an example, a high salt concentration has a negative impact on both the sludge activity and the size and stability of the sludge or biomass granules. In addition, inorganic precipitation, such as calcium carbonate, can reduce the biological activity and the mixing characteristics in granular biomass processes.

### SUMMARY OF THE INVENTION

The present invention relates to a granular sludge process for removing COD from a wastewater stream where the process internally dilutes the influent wastewater so as to reduce the concentration of these inhibiting constituents, thus improving the performance of the granular sludge process. In one embodiment, the internal dilution of the influent wastewater is such that the hydraulic retention time (HRT) in the granular sludge treatment phase is two days or less. This HRT tends to retain granular biomass and prevents flocculated biomass from outcompeting the granular biomass and interfering with the granular sludge process.

In one embodiment there is provided a wastewater treatment unit located downstream of the granular sludge process. Effluent from the granular sludge process is directed to the downstream treatment unit. The downstream treatment unit removes constituents or contaminants in the wastewater that inhibit or impair the performance of the anaerobic granular sludge process. The downstream treatment unit produces a treated effluent that includes a relatively low concentration of one or more of these inhibiting constituents. A portion of the treated effluent is recycled and mixed with the influent wastewater. This dilutes the concentration of inhibiting constituents that impair or reduce the effectiveness of the anaerobic granular sludge process.

In another aspect of the present invention, influent wastewater is directed to a reactor operated under anaerobic conditions where granular sludge is used to remove COD from the wastewater. After treating the wastewater with the granular sludge, the wastewater is sent, directly or indirectly, to an integrated fixed film activated sludge (IFAS) unit where ammonium, COD and TSS is removed from the wastewater. A treated effluent with a relatively low ammonium, COD and TSS concentration is produced. A portion of the treated effluent is recycled and mixed with the influent wastewater. This reduces the concentration of ammonium, COD and TSS in the wastewater being treated in the anaerobic granular sludge process. By reducing the ammonium, COD and TSS concentration of the wastewater being treated, the anaerobic granular sludge process is made more effective and efficient.

The IFAS unit may perform various wastewater treatment processes that enhance the anaerobic granular sludge process. The IFAS unit includes suspended biomass and biomass supported on biofilm carriers. In one IFAS process, the suspended biomass includes ammonium oxidizing bacteria (AOB). In this case, the biomass supported on the biofilm carriers is anaerobic ammonium oxidizing (ANAMMOX) bacteria. Together, the AOB and ANAMMOX bacteria can perform what is termed deammonification process in the IFAS unit and in the process can produce a treated effluent that has a relatively low ammonium concentration.

In another embodiment, the present invention relates to a method of treating influent wastewater that includes directing the wastewater into a treatment unit having granular sludge and operating the treatment unit under anaerobic conditions. COD is removed from the wastewater in the treatment unit by contacting the wastewater with the granular sludge. The method includes directing the effluent from the treatment unit to a partial nitrification and denitrification unit where partial nitrification to nitrite is performed by AOB, and denitrification is performed by heterotrophic bacteria. After treating the wastewater in the partial nitrification and denitrification unit, the method includes directing the wastewater to a clarifier or solid-liquid separator. Here the wastewater is clarified to produce sludge having AOB and the heterotrophic bacteria, as well as a treated effluent. The method further includes recycling at least some of the sludge and AOB and heterotrophic bacteria to the partial nitrification and denitrification unit. Further, the method includes diluting the influent wastewater by recycling at least a portion of the treated effluent produced by the clarifier and mixing the treated effluent with the influent wastewater to dilute the concentration of constituents in the wastewater that may adversely impact the granular sludge process carried out in the treatment unit.

In one embodiment, the partial nitrification and denitrification unit comprises an IFAS unit having biofilm carriers that are contained in the wastewater and wherein the method includes performing partial nitrification to nitrite with the AOB suspended in the IFAS unit and performing denitrification with the heterotrophic bacteria supported on the biofilm carriers.

Other objects and advantages of the present invention will become apparent and obvious from a study of the following description and the accompanying drawings which are merely illustrative of such invention.

### BRIEF DESCRIPTION OF THE DRAWINGS

FIG. 1 is a schematic illustration of an anaerobic granular sludge process in accordance with the present invention.

FIG. 2 is a schematic illustration showing an alternative anaerobic granular sludge process.

FIG. 3 depicts still another alternative anaerobic granular sludge process where the effluent from the granular sludge process is treated in an aerobic biological treatment unit.

FIG. 3A is a schematic illustration of yet another alternative anaerobic granular sludge process that incorporates a biological nutrient removal unit.

FIG. 3B is a schematic illustration showing an anaerobic granular sludge process that incorporates a flash aeration unit.

FIG. 4 is a schematic illustration showing an anaerobic granular sludge process that incorporates an integrated fixed film activated sludge process.

FIG. 5 is another anaerobic granular sludge process that incorporates an aerobic CBOD removal unit upstream of an integrated fixed film activated sludge process.

FIG. 6 is a schematic illustration of another anaerobic granular sludge process that is similar to the process shown in FIG. 5, except that there is provided a clarifier downstream of the aerobic CBOD removal unit.

### DESCRIPTION OF EXEMPLARY EMBODIMENT

The present invention relates to an anaerobic granular sludge process that can be employed to treat different wastewaters. It may be beneficial to briefly discuss anaerobic granular sludge processes and how they are employed in various processes. There are various ways for forming an anaerobic granular sludge process as appreciated by those skilled in the art. One anaerobic granular sludge process is referred to as an upflow anaerobic sludge blanket (UASB) process. Another anaerobic granular sludge process is referred to as an expanded granular sludge bed (EGSB) process. Both processes entail providing a granular sludge bed or fluidized bed in the lower portion of a reactor. This granular sludge bed includes naturally occurring microorganisms that form granules, typically 0.5 to 2 mm. in diameter. The biomass granules that form a part of the granular sludge bed resists washout, thereby allowing for high hydraulic loads.

Influent wastewater which contains an appreciable concentration of COD is fed into the lower portion of the reactor. Wastewater is directed upwardly through the granular sludge bed and, as noted above, the reactor is operated under anaerobic conditions, which means that there is no supplied air as well as no substantial concentration of NO₂ and NO₃. As the influent wastewater passes through the granular sludge bed, the granular biomass converts organic compounds to CO₂ and CH₄ through a basic anaerobic digestion process. This, of course, produces gas, particularly methane and CO₂, and the gas is vented out a top portion of the reactor 12 where it can be used as an energy source.

The parameters in the anaerobic granular sludge reactor can vary. In one embodiment, the pH is controlled and maintained at approximately 6 to 8. This facilitates the growth of bacteria that is capable of reducing the concentration of COD in the wastewater. In addition, in one embodiment, a temperature of 33-38° C. is considered optimum. Finally, while the COD concentrations in the influent wastewater will vary, in one embodiment it is recognized that it is beneficial for the COD concentrations to be relatively high, which means that the COD concentrations exceed 400 mg/L.

The HRT of the anaerobic granular sludge reactor in a preferred embodiment should be controlled such that the HRT is two days or less. Preferably maintaining the HRT at 2-20 hours is even more desirable. In some cases, an HRT of less than 2 hours increases the chance of washing out the granular biomass. If the HRT is allowed to extend over 2 days, there is an increased chance that flocculated biomass (that is, biomass other than granular biomass) will outcompete the granular biomass and hence adversely affect the anaerobic granular sludge process executed in reactor.

When the wastewater stream being treated includes a relatively high COD concentration (for example, more than 20,000 mg/L) employing an anaerobic granular sludge process is challenging. Part of the reason is because many high strength wastewaters also have high concentrations of calcium and/or magnesium or other total dissolved solids or salts (TDS). A high salt concentration has a negative impact on both the granular sludge activity and sludge granulation, i.e., the size and stability of the sludge granules. Also, inorganic precipitation, such as calcium carbonate, can also reduce the biological activity and the mixing characteristics in reactors that employ granular sludge to treat wastewater.

In cases where the influent COD is relatively high, at a certain volumetric loading rate, the hydraulic retention time (HRT) in an anaerobic granular sludge system is longer. The hydraulic selection pressure to wash out the flocculated biomass and retain granular biomass decreases when HRT increases. When more flocculated biomass is retained in the system, the flocculated biomass outcompetes the granular biomass and this causes degranulation to start and the system performance deteriorates. In addition, many high strength wastewaters also have a relatively high concentration of total kjeldahl nitrogen (TKN). High concentrations of free ammonia are inhibitory to methanogens.

Also, many high strength wastewaters contain elevated concentrations of organic compounds that inhibit the growth and proliferation of methanogens which are necessary for the efficient operation of anaerobic granular sludge processes. Furthermore, many high strength wastewaters also contain relatively high concentrations of total suspended solids (TSS). Anaerobic granular sludge processes are generally not effective at high TSS concentrations because high TSS concentrations affect anaerobic biomass granulation.

These wastewater constituents just described (e.g., TSS, TDS such as calcium and magnesium, ammonium and organic compounds) are termed inhibiting constituents, meaning that they tend to inhibit the effectiveness and efficiency of anaerobic granular sludge processes. The processes described herein are designed to reduce or minimize the adverse effects of these inhibiting constituents on anaerobic granular sludge processes. As described below, the processes of the present invention employ an anaerobic granular process to reduce COD concentrations in a wastewater stream but also incorporate various downstream treatment processes to reduce the concentrations of the inhibiting constituents and produce a treated effluent. The treated effluent is employed as an internal dilutant and is mixed with the influent wastewater to reduce the concentrations of these inhibiting constituents so that they do not substantially adversely impact the anaerobic granular sludge process.

As such, the processes of the present invention give rise to a hybrid high rate granular sludge process that can employ various processes to address the inhibiting constituents and their adverse impact on the effectiveness of the anaerobic granular sludge. In one example, a BNR process is employed downstream of the anaerobic granular sludge process. The incorporated BNR process has a number of positive effects on the hybrid high rate granular sludge process disclosed herein. For example, the effluent from the anaerobic granular sludge process normally contains relatively high concentrations of alkalinity (particularly bicarbonate) and dissolved CO₂. As a result of aeration in the BNR process, CO₂ is effectively stripped out in the aeration reactor or reactors. This will result in a pH increase and calcium carbonate and other solids will precipitate in the aeration reactor or reactors. This is an effective calcium removal process because the energy associated with aeration results in both the oxygen transfer and the CO₂ stripping at the same time. A final clarifier can be employed downstream of the BNR process and produces an effluent having a relatively low calcium concentration, for example about 60 mg/L or lower which constitutes a desirable dilution water for diluting the influent wastewater ahead of the anaerobic granular sludge process. This will result in a more overall TDS concentration and less inorganic precipitation in the anaerobic granular sludge process.

Mixing treated effluent with the influent wastewater to dilute the concentration of the COD decreases HRT in the anaerobic granular sludge process. This improves and enhances anaerobic biomass granulation. In addition, recycling of treated effluent from a downstream process will, in some cases, decrease ammonium and this in turn decreases the adverse effects of ammonium to methanogens in the anaerobic granular sludge. In some cases, an aerobic BNR process can biodegrade some COD that is inhibitory to the anaerobic granular sludge process. Therefore, treated effluent recycled to a point upstream of the anaerobic granular sludge process has the potential to reduce the organic inhibitory effects on the anaerobic granular sludge process. Recycling treated effluent from the downstream process will dilute the concentration of TSS in the influent wastewater.

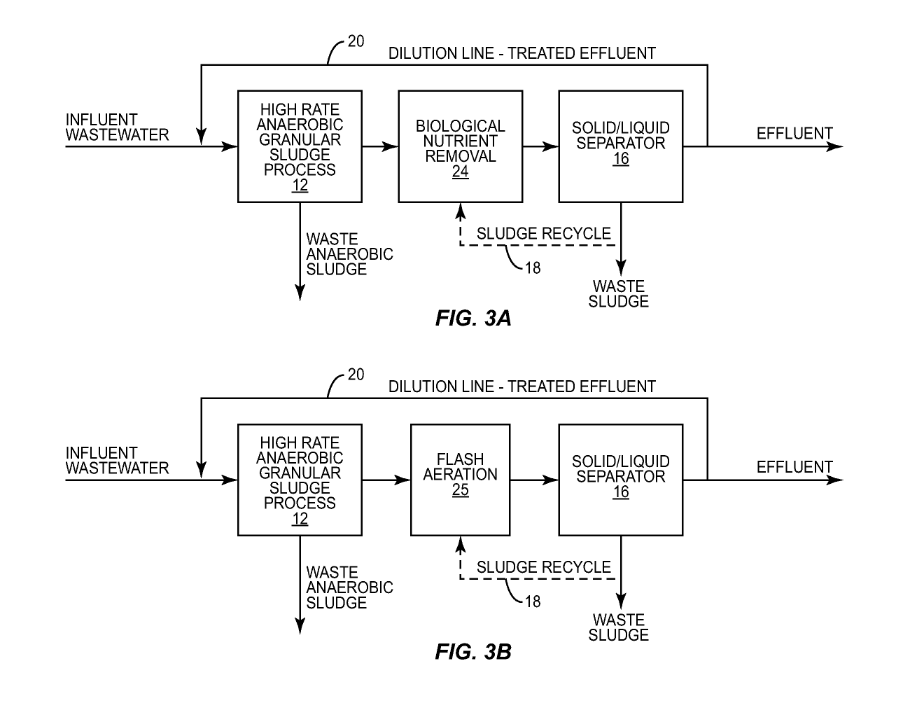

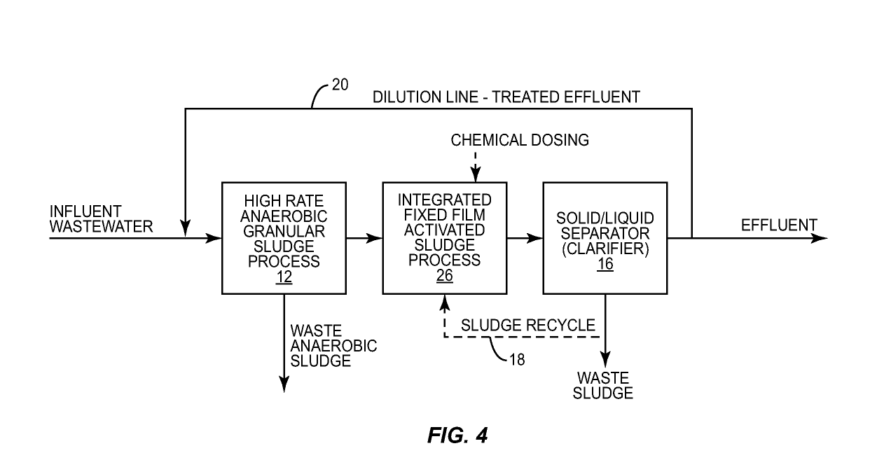

Turning to the drawings, there is shown therein a number of hybrid high rate anaerobic granular sludge processes that are indicated generally by the numeral 10. Viewing the basic system and process shown therein, there is provided a first reactor 12 that is referred to as a granular sludge reactor. Reactor 12 can include multiple tanks or stages. Downstream from the first reactor 12 are various treatment units that are configured and adapted to treat the effluent from reactor 12. The function of the downstream treatment units are to remove or reduce the concentrations of one or more of the inhibiting constituents that adversely affect the performance and efficiency of the anaerobic granular sludge process that takes place in the reactor 12. In one example, the downstream treatment unit is an aerobic biological reactor. See FIG. 3. In another example, the downstream treatment unit is a biological nutrient removal unit that removes, for example, nitrogen from the effluent produced by the anaerobic granular sludge process in reactor 12. See, for example, FIG. 3A. In other cases, the downstream treatment unit may be an integrated fixed film activated sludge (IFAS) process that can be employed in various ways to remove various constituents that inhibit the effectiveness of the anaerobic granular sludge process. See FIGS. 4-6. These various downstream processes will be described later in more detail.

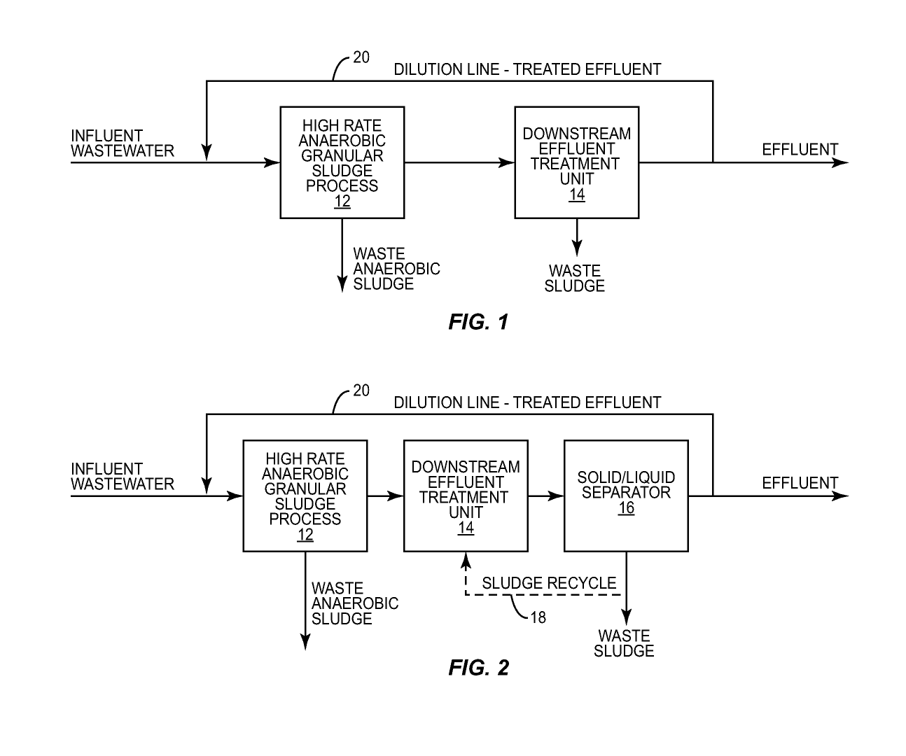

The downstream treatment units may alone produce a treated effluent that is utilized to dilute the influent wastewater. See FIG. 1. By diluting the influent wastewater, the concentrations of inhibiting constituents in the wastewater are reduced and this reduces the adverse impact of these inhibiting constituents on the anaerobic granular sludge process. In other cases, there is a solid-liquid separator, a clarifier for example, located downstream of the treatment unit. Effluent from the downstream treatment unit is directed into the solid-liquid separator. The solid-liquid separator separates the effluent into a treated effluent and sludge. The treated effluent from the solid-liquid separator is recycled to the front of the process where it is mixed with the influent wastewater to dilute the concentration of the inhibiting constituents discussed herein. Detail of the various processes disposed downstream of the anaerobic granular sludge process will be discussed subsequently herein.

Various treatment processes can be employed downstream of reactor 12 to enhance the anaerobic granular sludge process. For example, in some cases, the ammonium nitrogen, NH₄—N, concentration in the influent wastewater is substantial and adversely impacts the effectiveness of the anaerobic granular sludge process. In these cases, it is desirable to provide a downstream nitrification de-nitrification process that reduces the ammonium concentration of the wastewater and produces a treated effluent that can be used as an internal dilutant that is mixed with the influent wastewater to effectively reduce the concentration of the ammonium in the reactor 12.

Conventionally, to remove ammonium nitrogen, a two step process is called for, nitrification and denitrification. In this conventional approach to removing ammonium nitrogen, the process entails a first step which is referred to as a nitrification step and which entails converting the ammonium nitrogen to nitrate and a very small amount of nitrite, both commonly referred to as NO_{X}. Many conventional activated sludge wastewater treatment processes accomplish nitrification in an aerobic treatment zone. In the aerobic treatment zone, the wastewater containing the ammonium nitrogen is subjected to aeration and this gives rise to a microorganism culture that effectively converts the ammonium nitrogen to NO_{X}. Once the ammonium nitrogen has been converted to NO_{X}, then the NO_{X}-containing wastewater is typically transferred to an anoxic zone for the purpose of denitrification. In the denitrification treatment zone, the NO_{X}-containing wastewater is held in a basin where there is no supplied air and this is conventionally referred to as an anoxic treatment zone. Here a different culture of microorganisms operate to use the NO_{X} as an oxidation agent and thereby reduces the NO_{X} to free nitrogen which escapes to the atmosphere

In some cases, conventional nitrification and denitrification processes have a number of drawbacks. First, conventional nitrification and denitrification processes require substantial energy in the form of oxygen generation that is required during the nitrification phase. Further, conventional nitrification and denitrification may require a substantial supply of external carbon source.

The ammonium in certain waste stream can be reduced by utilizing different bacteria from those normally associated with conventional nitrification-denitrification. In this case, a typical process, sometimes referred to as denitrification, combines nitritation and anaerobic ammonium oxidation (ANAMMOX). In the nitritation step, ammonium oxidizing bacteria oxidize a substantial portion of the ammonium in the waste stream to nitrite (NO₂⁻). Then in the second step, the ANAMMOX bacteria or biomass converts the remaining ammonium and the nitrite to nitrogen gas (N₂) and in many cases a small amount of nitrate (NO₃⁻). The second step can also be heterotrophic bacteria or biomass converts the nitrite to nitrogen gas.

Therefore, in the present case, it may be desirable to implement such a deammonification process downstream of the reactor 12. This will effectively remove ammonium, COD and TSS from the wastewater such that the treated effluent stream directed back through the internal sludge recycle line 18 will not include a significant concentration of ammonium, COD and TSS, hence, will effectively dilute the ammonium COD and TSS concentration in the influent wastewater such that it does not substantially adversely impact the anaerobic granular process that takes place in reactor 1.

FIGS. 1-6 depict various high rate anaerobic granular sludge processes for removing COD from influent wastewater streams. Each will be briefly discussed. In the case of the FIG. 1 embodiment, influent wastewater is directed into the first reactor 12 where an anaerobic granular sludge process is carried out to remove COD from the influent wastewater. As discussed above, typically the influent wastewater will include constituents that adversely affect the anaerobic granular sludge process. For example, the following conditions tend to adversely impact the effectiveness and efficiency of granular sludge processes.
Where COD in the influent wastewater exceeds 10,000 mg/l.
Where the ratio of TSS to COD exceeds 0.1.
Where calcium and magnesium in the influent wastewater exceeds 600 mg/l.
Where total dissolved solids in the influent wastewater exceeds 10,000 mg/l.
Where TKN in the influent wastewater exceeds

$$328 ( \frac{{e}^{\frac{6344}{T}}}{{10}^{p H}} + 1 ) ,$$

where the pH (normal unit) and T (Kelvin) are the pH and temperature in the anaerobic reactor. To address these problems, the present invention provides a downstream effluent treatment unit 14 that is designed to remove one or more of the inhibiting constituents from the effluent from the anaerobic granular sludge process. The downstream effluent treatment unit 14 may or may not include an associated solid-liquid separator. In the case of the FIG. 1 embodiment, the treated effluent produced by the downstream treatment unit 14 is recycled through dilution line 20 to a point in the process upstream of first reactor 12, or in some cases directly to the reactor 12. Since at least some of the inhibiting constituents have been removed from the wastewater, it follows that mixing the treated effluent with the influent wastewater effectively dilutes the concentration of one or more of the inhibiting constituents such that the overall performance and effectiveness of the anaerobic granular sludge process is improved. As discussed above, there are a number of inhibiting constituents typically found in influent wastewater streams. These include total suspended solids, dissolved solids, particularly calcium and magnesium, ammonium and organic compounds. Thus, in the case of the FIG. 1 embodiment, the downstream effluent treatment unit 14 can be designed and configured to reduce the concentration of one or more of these inhibiting constituents to produce a treated effluent stream whose concentrations of at least some of these inhibiting constituents is relatively low. Thus, the treated effluent that is recycled and mixed with the influent wastewater effectively conditions the influent wastewater to have a relatively low concentration of these inhibiting constituents such that they do not adversely affect the high rate anaerobic granular sludge process that is carried out in reactor 12.

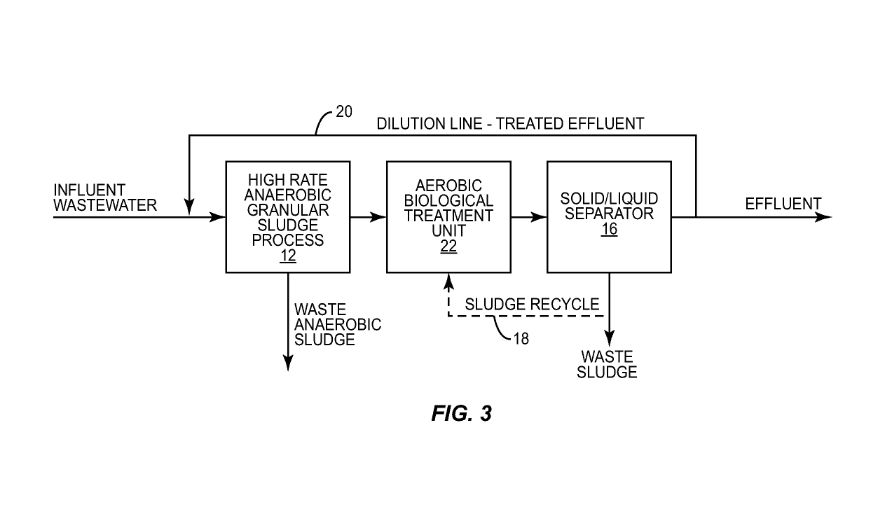

The FIG. 2 embodiment is similar to the FIG. 1 embodiment with the exception that there is provided a solid-liquid separator 16 downstream from the downstream effluent treatment unit 14. In this embodiment, the effluent from the treatment unit 14 is directed to the solid-liquid separator which separates the effluent into treated effluent and sludge. As seen in FIG. 2, a portion of the sludge can be wasted and, as an option, a portion of the sludge can be recycled via line 18 to the treatment unit 14. As with the FIG. 1 embodiment, a portion of the treated effluent produced by the solid-liquid separator 16 can be recycled and mixed with the wastewater influent upstream of the anaerobic granular sludge process.

Turning now to the FIG. 3 embodiment, it is seen that the effluent from the anaerobic granular sludge process is directed to an aerobic biological treatment unit 22. Aerobic biological treatment unit 22 targets specific constituents in the wastewater that impair the performance of the anaerobic granular sludge process. In one example, the aerobic biological treatment unit 22 can be employed to perform nitrification. In this case and as an option, an associated denitrification unit can be employed with the aerobic biological treated unit 22. Again, the process produces a treated affluent where a portion of the treated affluent is recycled and mixed with the influent wastewater to reduce the concentration of constituents that impair the performance of the anaerobic granular sludge process.

Turning to FIG. 3A, there is shown therein a high rate anaerobic granular sludge process where the effluent from the granular sludge process is treated in a biological nutrient removal (BNR) 34 process. Here the aim is to reduce the concentration of nutrients in the influent wastewater stream that impair the performance and effectiveness of the granular sludge process carried out in reactor 12. Thus, the BNR unit 24 is designed to produce a treated effluent that has a relatively low nutrient concentration such that when a portion of the treated effluent is recycled and mixed with the influent wastewater, the concentration of inhibiting nutrients in the wastewater is reduced.

Biological nutrient removal unit 24 can assume various configurations and, as noted above, can be aimed at various contaminants. In one example, the biological nutrient removal unit 24 can be provided with aerobic and anoxic zones to perform conventional nitrification-denitrification. In other examples, the biological nutrient removal unit 24 can be configured to perform deammonification using AOB and ANAMMOX bacteria.

FIG. 3B shows another anaerobic granular sludge process that is similar in many respects to the processes shown in FIGS. 3A and 3B. The basic difference is that the process in FIG. 3B includes a flash aeration unit 25 disposed downstream of the anaerobic granular sludge process 12. The effluent directed to the flash aeration unit 25 will normally contain considerable dissolved CO₂. This is because the biogas produced in the anaerobic granular sludge reactor 12 typically contains about 40% CO₂. Air stripping off the dissolved CO₂ will raise the pH of the wastewater in the flash aeration unit 25. When the pH increases, calcium and magnesium will precipitate and these calcium and magnesium precipitants will be removed in the downstream clarifier. The hydraulic retention time of the flash aeration unit is generally between 0.5 and 10 hours and preferably between 1 and 4 hours. The anaerobic granular sludge process that employs a flash aeration unit 25 is especially desirable when the major inhibiting constituents in the influent wastewater are calcium and magnesium. The process depicted in FIG. 3B is especially effective when COD, TSS and TKN are not a significant issue and there is a considerable concentration of calcium and/or magnesium in the influent wastewater. Effluent from the flash aeration unit 25 is directed to a solid-liquid separator or a clarifier which is effective to remove suspended solids from the effluent from the flash aeration unit. As with other processes described herein, the solid-liquid separator produces a supernatant or treated effluent stream and a portion of that stream or effluent is recycled to be mixed with the influent wastewater so as to dilute constituents that might have an adverse effect on the anaerobic granular sludge process that takes place upstream of the flash aeration unit 25.

In the FIG. 4 process, effluent from the granular sludge process is directed to integrated fixed film activated sludge (IFAS) unit 26. IFAS unit 26 can be configured to reduce the concentration of numerous constituents that may impair the performance and effectiveness of granular sludge process. Fundamentally, the IFAS unit includes suspended biomass, as well as biomass supported on biofilm carriers. The combination of suspended biomass and supported biomass can perform numerous wastewater treatments. In one example, the IFAS unit 26 can be employed to reduce the ammonium concentration in the wastewater. This can be accomplished through a deammonification process where the suspended biomass comprises AOB or ANAMMOX bacteria. In this case, the suspended AOB is effective to perform partial nitrification, sometimes referred to as nitritation. The ANAMMOX bacteria supported on the biofilm carriers complete the denitrification process in the IFAS unit 26. This results in the treated effluent having a substantially reduced ammonium concentration. Thus, when the treated effluent of the FIG. 4 process is recycled and mixed with the influent water, it follows that this dilutes the ammonium concentration in the wastewater and thereby improves the overall performance of the anaerobic granular sludge process.

It should be pointed out that in the FIG. 4 process the sludge produced by the solid-liquid separator 16 includes AOB. The AOB that forms a part of the sludge is recycled to the IFAS unit 26. This enhances the deammonification process that takes place in the IFAS unit. It also should be pointed out that chemical dosing, as an option, can be utilized to improve and enhance the deammonification process that takes place in the IFAS unit 26.

To illustrate the anaerobic granular sludge process of FIG. 4, some exemplary operating data may be helpful. In the case of the FIG. 4 embodiment, assume that the anaerobic granular sludge reactor 12 has a volume of 1,000 m³, a VLR of 15 and an HRT of 1.3 days. Also assume that the IFAS unit 26 has a volume of 328 m³ and is 50% filled so the surface area of the biofilm carriers or media is 131,200 m². Assume the IFAS system has MLSS concentration of 2,500 ppm, and the AOB in the MLSS effectively converts ammonia to nitrite, so the surface nitrogen loading rate of the biofilm can increase to 5 g-N/m²/day, therefore the IFAS unit can remove 656 Kg·m/day. It is appreciated that process variables of the FIG. 4 process will vary depending on influent wastewater characteristics and the particular processes that are employed in the individual treatment units. Table A appearing below presents exemplary data that is anticipated in the case of the exemplary process shown in FIG. 4.

TABLE A

| | | | Granular | Recycle | |
|---|---|---|---|---|---|
| | Waste- | Diluted | Sludge | (Internal | |
| Process | water | Waste- | Process | Dilution | Final |
| Variable | Influent | water | Effluent | Stream) | Effluent |
| COD, ppm | 62,000 | 20,104 | 2500 | 1,000 | 1000 |
| TSS, ppm | 1,643 | 535 | 500 | 30 | 30 |
| TKN, ppm | 2,814 | 929 | 900 | 70 | 70 |
| Q, m³/d | 228 | 728 | 728 | 500 | 228 |

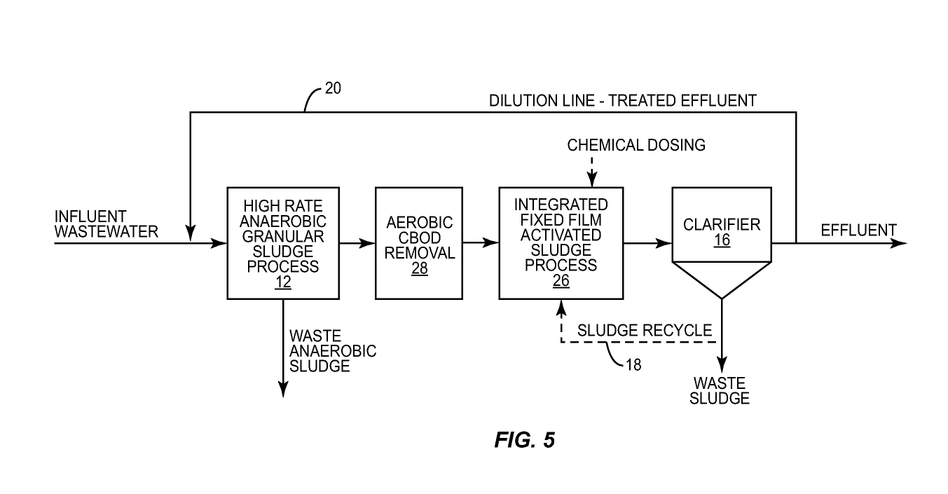

Turning now to FIG. 5, there is shown therein another alternate embodiment for the anaerobic granular sludge process of the present invention. This process is similar to the process shown in FIG. 4 with the exception that there is provided aerobic CBOD removal unit 28 that is interposed between the first reactor 12 and the IFAS unit 26. In this case, unit 28 is designed or configured to remove carbonaceous biochemical oxygen demand (CBOD). By specifically removing COD or CBOD, it follows that the treated effluent that is ultimately recycled to dilute the influent water includes a relatively low concentration COD or CBOD especially those COD that is unbiodegradable or even inhibitory in anaerobic process. Thus, the treated effluent that is mixed with the influent wastewater does not further load the process with COD or CBOD which is inhibitory to anaerobic process. Hence, this enhances the performance of the anaerobic granular sludge process.

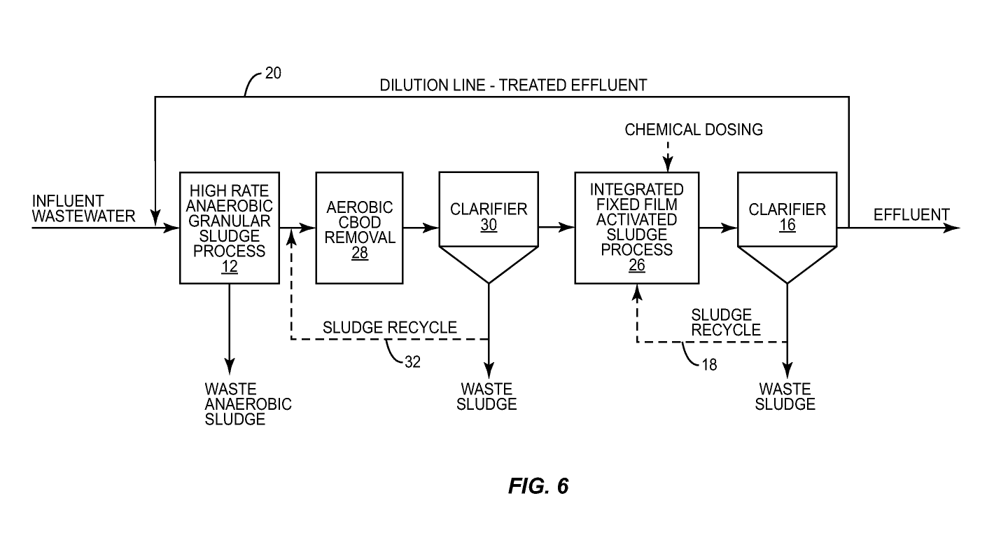

Finally, in the alternate embodiment shown in FIG. 6, the process depicted therein is similar to the process shown in FIG. 5, except that there is provided an additional clarifier, clarifier 32, located downstream of the aerobic CBOD removal unit 28. Essentially, clarifier 32 functions to remove suspended solids from the wastewater stream upstream of the IFAS unit 26. Some of the suspended solids are wasted as sludge. As an option, some of the sludge produced by clarifier 32 can be recycled to the aerobic CBOD removal unit 28 in order to enhance the biological treatment therein.

It should be pointed out that, as an option, various processes depicted in FIGS. 2-6 may be provided with an optional additional treatment unit downstream of the solid-liquid separators 16. It is appreciated that such treatment units downstream of the solid-liquid separators discussed above may provide another treated effluent stream and a portion of that effluent stream can be recycled and mixed with the influent wastewater to further reduce the concentration of constituents that inhibit the performance of the high rate anaerobic granular sludge process. There are many advantages to the hybrid high rate anaerobic granular sludge process discussed above and shown in FIGS. 1-6. One embodiment of the anaerobic granular sludge process provides the downstream IFAS unit 26 which can employ AOB and ANAMMOX bacteria to carry out a deammonification process. Here the IFAS unit contains a high concentration of AOB. Thus, the nitritation reaction rate is faster and this provides more nitrite to increase the anaerobic ammonium oxidation rate in the IFAS unit. Thus, the overall autotrophic nitrogen removal rate is increased. As depicted in Table A, the recycle of clarifier supernatant to dilute the influent wastewater, in one example, results in the COD concentration being reduced from 62,000 ppm to about 20,104 ppm. TSS is reduced from 1643 ppm to about 535 ppm. This will reduce the HRT in the anaerobic granular sludge reactor from 4.4 days to 1.3 days. This dilution, without using external dilution water, increases the hydraulic selection pressure to wash out flocculated biomass and retain granular biomass in the process of the present invention. Also, as depicted in Table A in one example, the recycle of a portion of the supernatant or treated effluent decreases the influent TKN from 2,814 ppm to 929 ppm. This will decrease the free ammonia inhibition to the anaerobic granular sludge process. Also, it is appreciated that the present invention will decrease the alkalinity and pH in the anaerobic granular process reactor 12. When treating very high strength wastewater, the alkalinity and pH in the anaerobic bioreactor 12 can be too high. Because alkalinity will be used in the ANAMMOX nitrogen removal process in some embodiments, the recycle of treated effluent will effectively decrease the alkalinity and pH and this will benefit the anaerobic granular sludge process. In the FIGS. 5 and 6 embodiments, the aerobic CBOD unit 28, along with the IFAS unit 26, can be employed in an efficient way to precipitate some calcium and magnesium from the wastewater as a result of CO₂ air stripping and pH increase. Thus, the recycle supernatant or treated effluent will dilute the total dissolved solids (including calcium and magnesium) in the influent wastewater which may be beneficial to the high rate anaerobic granular sludge process. The high rate anaerobic granular sludge process and the IFAS unit operated with ANAMMOX bacteria are COD and nitrogen load limited processes. Thus, the recycle of clarifier supernatant or treated effluent will not typically call for increases in tank volume. The size of the clarifier may increase because solids and hydraulic loading rates will increase. However, compared to the cost of increasing the volume of certain treatment units in the process, the cost of increasing the capacity of the clarifier is relatively inexpensive.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of employing granular sludge to remove chemical oxygen demand (COD) from influent wastewater and removing constituents from the wastewater that impair the formation and effectiveness of granular sludge in reducing the concentration of COD in the wastewater, the method comprising:
directing the influent wastewater into a first reactor having the granular sludge and operating the reactor under anaerobic conditions and contacting the influent wastewater with the granular sludge to remove COD from the influent wastewater;
directing the influent wastewater from the first reactor to a downstream treatment unit;
in the downstream treatment unit, reducing the concentration of one or more of the inhibiting constituents and producing a treated effluent; and
substantially reducing the concentration of the inhibiting constituents in the influent wastewater by diluting the influent wastewater with at least part of the treated effluent of the downstream treatment unit.

2. The method of claim 1 wherein the concentration of COD in the influent wastewater exceeds 10,000 mg/L.

3. The method of claim 1 wherein the ratio of total suspended solids to COD in the influent wastewater exceeds 0.1.

4. The method of claim 1 wherein the calcium and magnesium in the influent wastewater exceeds 600 mg/l.

5. The method of claim 1 wherein the total dissolved solids in the influent wastewater exceeds 10,000 mg/l.

6. The method of claim 1 where total nitrogen (TKN) in the influent wastewater exceeds
$$328 ( \frac{{e}^{\frac{6344}{T}}}{{10}^{p H}} + 1 ) ,$$
where the pH and T are the pH and temperature in the first reactor.

7. The method of claim 1 including controlling the hydraulic retention time (HRT) in the first reactor by recycling a sufficient amount of the treated effluent to maintain the HRT of the first reactor at less than 2 days.

8. The method of claim 1 including raising the pH of the wastewater by stripping off the dissolved CO₂ or by chemical addition in the downstream treatment unit and precipitating dissolved solids from the wastewater in the downstream treatment unit.

9. The method of claim 8 wherein the downstream treatment unit includes a flash aeration reactor to be followed by a clarifier which produces the treated effluent; and wherein at least a portion of the treated effluent from the clarifier is recycled and mixed with the influent wastewater to dilute the concentration of one or more of the inhibiting constituents.

10. The method of claim 9 where the flash aeration reactor has an Hydraulic Retention Time between 0.5 and 10 hours.

11. The method of claim 1 wherein the downstream treatment unit includes an aerobic bioreactor that produces an effluent that is clarified in a downstream clarifier which produces the treated effluent; and wherein at least a portion of the treated effluent from the clarifier is recycled and mixed with the influent wastewater to dilute the concentration of one or more of the inhibiting constituents.

12. The method of claim 1 wherein the downstream treatment unit includes a biological nutrient removal (BNR) process.

13. The method of claim 12 including directing effluent from the first reactor to the BNR process and performing partial or full nitrification on the effluent from the first reactor.

14. The method of claim 12 including directing effluent from the first reactor to the BNR process and performing partial or full nitrification and heterotrophic or autotrophic de-nitrification on the effluent from the first reactor.

15. The method of claim 1 wherein the downstream treatment unit includes an integrated fixed film activated sludge (IFAS) unit and wherein an anaerobic granular sludge process is carried out in the first reactor and wherein an effluent produced in the anaerobic granular sludge process is treated in the IFAS unit.

16. The method of claim 15 including removing ammonium and COD from the aerobic granular sludge effluent in the IFAS unit.

17. The method of claim 15 including directing the wastewater from the IFAS unit to a clarifier and clarifying the wastewater to produce the treated effluent and sludge and recycling at least a part of the sludge to the IFAS unit.

18. The method of claim 1 wherein the downstream treatment unit includes an IFAS unit that includes suspended ammonium oxidizing bacteria (AOB) and anaerobic ammonium oxidizing (ANAMMOX) bacteria supported on biofilm carriers in the IFAS unit; and the method includes reducing the ammonium concentration in the wastewater in the IFAS unit by contacting the wastewater with the AOB and ANAMMOX bacteria.

19. The method of claim 18 including directing the wastewater from the IFAS unit to a clarifier and clarifying the wastewater to produce the treated effluent and sludge including the AOB and recycling at least a part of the sludge having the AOB to the IFAS unit.

20. A method of removing COD from ammonium containing influent wastewater via an anaerobic granular sludge process and conditioning the influent wastewater to reduce the adverse effects on the anaerobic granular sludge process, the method comprising:
directing the wastewater into a reactor having granular sludge and operating the reactor under anaerobic conditions;
removing COD from the wastewater in the reactor by contacting the wastewater with the granular sludge; and
directing the effluent from the reactor to an integrated fixed film activated sludge (IFAS) unit having biofilm carriers contained therein, anaerobic ammonium oxidizing (ANAMMOX) bacteria supported on the biofilm carriers, and suspended ammonium oxidizing bacteria (AOB);
in the IFAS unit, removing ammonium from the wastewater by performing a deammonification process where partial nitrification is performed by the AOB, and wherein anaerobic ammonium oxidation is performed by the ANAMMOX bacteria supported on the biofilm carriers;
after treating the wastewater in the IFAS unit, directing the wastewater to a clarifier;
clarifying the wastewater to produce sludge having AOB and treated effluent;
recycling at least some of the sludge and AOB to the IFAS unit; and
diluting the concentration in the influent wastewater by recycling at least a portion of the treated effluent produced by the clarifier and mixing the treated effluent with the wastewater influent.

21. The method of claim 20 including a moving bed bioreactor disposed between the reactor having the granular sludge and the IFAS unit and wherein the moving bed bioreactor reduces mainly the concentration of carbonaceous biochemical oxygen demand (CBOD) in the wastewater.

22. The method of claim 21 wherein there is provided a second clarifier downstream from the moving bed bioreactor for clarifying effluent from the moving bed bioreactor.

23. The method of claim 20 including controlling the hydraulic retention time (HRT) in the reactor having the granular sludge by mixing a sufficient amount of the treated effluent with the influent wastewater to maintain the HRT of the reactor at one day or less preferably less than 2 days.

24. A method of treating influent wastewater, comprising:
directing the wastewater into a treatment unit having granular sludge and operating the treatment unit under anaerobic conditions;
removing COD from the wastewater in the treatment unit by contacting the wastewater with the granular sludge; and
directing the effluent from the treatment unit to a partial nitrification and denitrification unit where partial nitrification to nitrite is performed by AOB, and denitrification is performed by heterotrophic bacteria;
after treating the wastewater in the partial nitrification and denitrification unit, directing the wastewater to a clarifier;
clarifying the wastewater to produce sludge having AOB and the heterotrophic bacteria and treated effluent;
recycling at least some of the sludge and AOB and heterotrophic bacteria to the partial nitrification and denitrification unit; and
diluting the influent wastewater by recycling at least a portion of the treated effluent produced by the clarifier and mixing the treated effluent with the wastewater.

25. The method of claim 24 wherein the partial nitrification and denitrification unit comprises an IFAS unit having biofilm carriers that are contained in the wastewater therein and wherein the method includes performing partial nitrification to nitrite with the AOB suspended in the IFAS unit and performing de-nitrification with the heterotrophic bacteria supported on the biofilm carriers.

26. The method of claim 24 including controlling the hydraulic retention time (HRT) in the treatment unit having the granular sludge by mixing a sufficient amount of the treated effluent with the influent wastewater to maintain the HRT of the treatment unit at one day or less preferably less than 2 days.
